(19) United States
(12) Patent Application Publication
(10) Pub. No.: US 2022/0121769 A1
(43) Pub. Date: Apr. 21, 2022

(54) SYSTEM AND METHOD FOR FACILITATING MULTI-LEVEL SECURITY OF DATA IN DISTRIBUTED ENVIRONMENT

(71) Applicant: Cognitive Space, Manvel, TX (US)

(72) Inventor: Paul M. Bailey, Canyon Lake, TX (US)

(73) Assignee: Cognitive Space

(21) Appl. No.: 17/503,414

(22) Filed: Oct. 18, 2021

Related U.S. Application Data
(60) Provisional application No. 63/093,820, filed on Oct. 20, 2020.

(51) Int. Cl. G06F 21/62; G06F 9/54

(52) U.S. Cl. CPC G06F 21/6227; G06F 2221/2113; G06F 9/541

(57) ABSTRACT

A system and method for facilitating multi-level security of data through blockchain network is disclosed. The method includes receiving a request for accessing a specific resource stored in a blockchain node. The method further includes determining hierarchical level of the blockchain node, sensitivity level of the specific resource within the blockchain node, access level of the user requesting access of the specific resource. Further, the method includes validating the received request based on the location of the blockchain node, the determined hierarchical level of the blockchain node, the determined sensitivity level of the specific resource and the determined access level of the use and providing access of the requested specific resource.

### EARLIEST PRIORITY DATE

This Application claims priority from a Provisional patent application filed in the United States of America having Patent Application No. 63/093,820, filed on Oct. 20, 2020, and titled “SYSTEM AND METHOD FOR MULTI-LEVEL SECURITY OF DATA THROUGH PARTITIONED BLOCKCHAIN”.

### FIELD OF INVENTION

Embodiments of the present disclosure relate to data security and more particularly relates to a system and a method for facilitating multi-level security of data through blockchain network.

### BACKGROUND

Blockchain is a technology used for creating a database. A blockchain-based storage system prepares data for storage by creating data shards or segments, encrypting the segments, generating a unique hash for each segment, and creating redundant copies of each segment.

FIG. 1 is a pictorial depiction of a traditional blockchain architecture, in accordance with a prior-art. A buyer 102 creates a block 104 representing a transaction. Further, the block 104 is distributed and validated via a cryptographic hashing algorithm 106. The block 104 is committed to a traditional blockchain network 108, and miners are rewarded. Furthermore, a seller 110 receives the block 104. The traditional blockchain architecture is used for creating a database in which all nodes in the traditional blockchain network 108 have a copy of all data in the database. Moreover, each node in the traditional blockchain network 108 includes a full picture of the database. Thus, it is impossible to provide a multi-level security platform to secure the data. Further, the traditional blockchain architecture fails to classify the data stored in the database according to a sensitivity level of the data. Furthermore, all users may access the data at every node of the traditional blockchain network 108, which may lead to compromise in the security of the data as the traditional blockchain network 108 is unable to place restrictions on a particular user corresponding to a particular set of the data from the database.

Hence, there is a need for a system and method for facilitating multi-level security of data through blockchain network in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for facilitating multi-level security of data through blockchain network is disclosed. The computing system includes one or more hardware processors and a memory coupled to the one or more hardware processors. The memory includes a plurality of modules in the form of programmable instructions executable by the one or more hardware processors. The plurality of modules include a data receiver module configured to receive a request from a user for accessing a specific resource stored in a blockchain node of a blockchain network. The plurality of modules also include a data determination module configured to determine hierarchical level of the blockchain node within the blockchain network based on location of the blockchain node including the specific resource and the received request. Further, the data determination module is configured to determine sensitivity level of the specific resource within the blockchain node based on the location of the blockchain node. The data determination module is configured to determine access level of the user requesting access of the specific resource based on one or more user parameters. The one or more user parameters include name, address, ID number and designation of the user. The plurality of modules further include a data validation module configured to validate the received request based on the location of the blockchain node, the determined hierarchical level of the blockchain node, the determined sensitivity level of the specific resource and the determined access level of the user. Also, the plurality of modules include a data access module configured to provide access of the requested specific resource to the user upon successful validation of the received request.

In accordance with another embodiment of the present disclosure, a method for facilitating multi-level security of data through blockchain network is disclosed. The method includes receiving a request from a user for accessing a specific resource stored in a blockchain node of a blockchain network. The method also includes determining hierarchical level of the blockchain node within the blockchain network based on location of the blockchain node including the specific resource and the received request. Further, the method includes determining sensitivity level of the specific resource within the blockchain node based on the location of the blockchain node. Also, the method includes determining access level of the user requesting access of the specific resource based on one or more user parameters. The one or more user parameters include name, address, ID number and designation of the user. The method further includes validating the received request based on the location of the blockchain node, the determined hierarchical level of the blockchain node, the determined sensitivity level of the specific resource and the determined access level of the user. Furthermore, the method includes providing access of the requested specific resource to the user upon successful validation of the received request.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a pictorial depiction of traditional blockchain architecture, in accordance with a prior art;

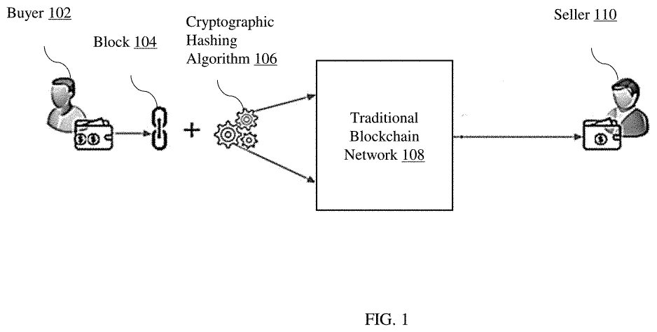

FIG. 2 is a schematic representation of blockchain networks facilitating multi-level security of data, in accordance with an embodiment of the present disclosure;

FIG. 3 is a block diagram illustrating an exemplary computing system for facilitating multi-level security of the data through blockchain network, in accordance with an embodiment of the present disclosure;

FIG. 4 is a schematic representation of a blockchain node for facilitating multi-level security of the data through the blockchain network, in accordance with an embodiment of the present disclosure; and

FIG. 5 is a process flow diagram illustrating an exemplary method for facilitating multi-level security of the data through the blockchain network, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Although the explanation is limited to a single user. However, it should be understood by the person skilled in the art that the computing system is applied if there are more than one user.

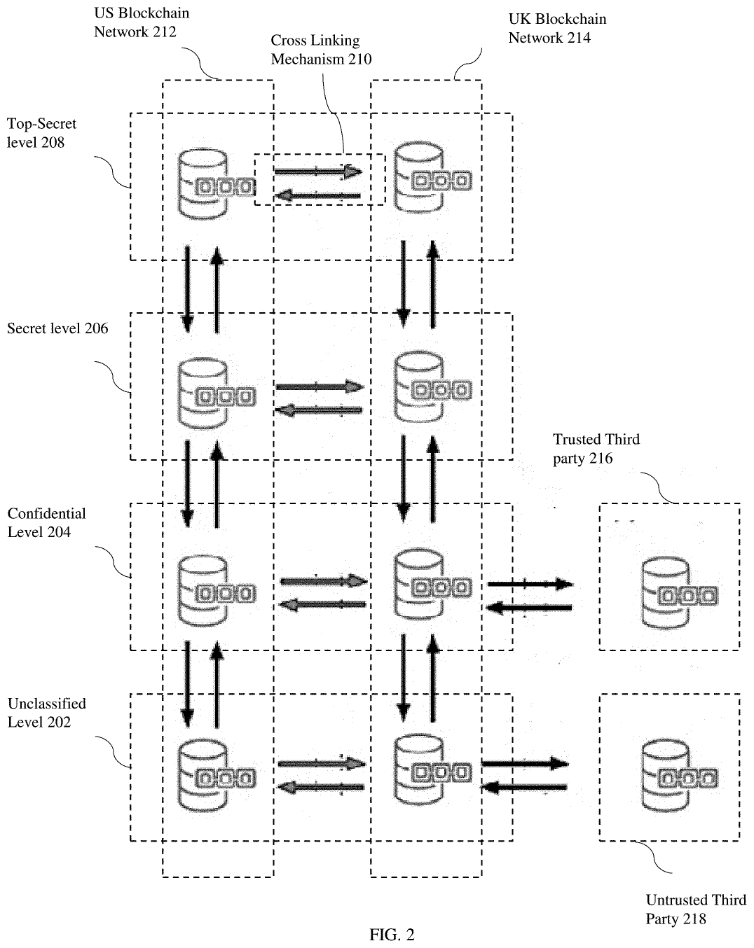

Referring now to the drawings, and more particularly to FIG. 2 through FIG. 5, where similar reference characters denote corresponding features consistently throughout the figures, there are shown preferred embodiments and these embodiments are described in the context of the following exemplary system and/or method.

FIG. 2 is a schematic representation of blockchain networks facilitating multi-level security of data, in accordance with an embodiment of the present disclosure. The blockchain network is a decentralized peer-to-peer immutable data storage. In an exemplary embodiment of the present disclosure, resources may be stored at four hierarchical levels of a plurality of blockchain nodes within blockchain networks. For example, the four hierarchical levels are unclassified level 202, confidential level 204, secret level 206 and top-secret level 208. The plurality of blockchain nodes in the blockchain network comprises hierarchically distributed resources. In an embodiment of the present disclosure, each of the resources may include a set of transactions. The hierarchically distributed resources include a highest sensitivity level of the resources up till a lowest sensitivity level of the resources. In an embodiment of the present disclosure, resources with highest sensitivity level may be stored at the top-secret level 208. Further, resources with lowest sensitivity level may be stored at the unclassified level 202. In an embodiment of the present disclosure, the resources may be shared between the blockchain networks via cross-linking mechanism 210. In an embodiment of the present disclosure, the cross-linking mechanism is a publish/subscribe API. In an exemplary embodiment of the present disclosure, the blockchain networks may be regional blockchain networks, such as US blockchain network 212 and UK blockchain network 214. Furthermore, a trusted third party 216 may access the resource at the confidential level 204 having higher hierarchical level than the unclassified level 202. In an embodiment of the present disclosure, an untrusted third party 218 may access the resource at the unclassified level 202 having lowest hierarchical level.

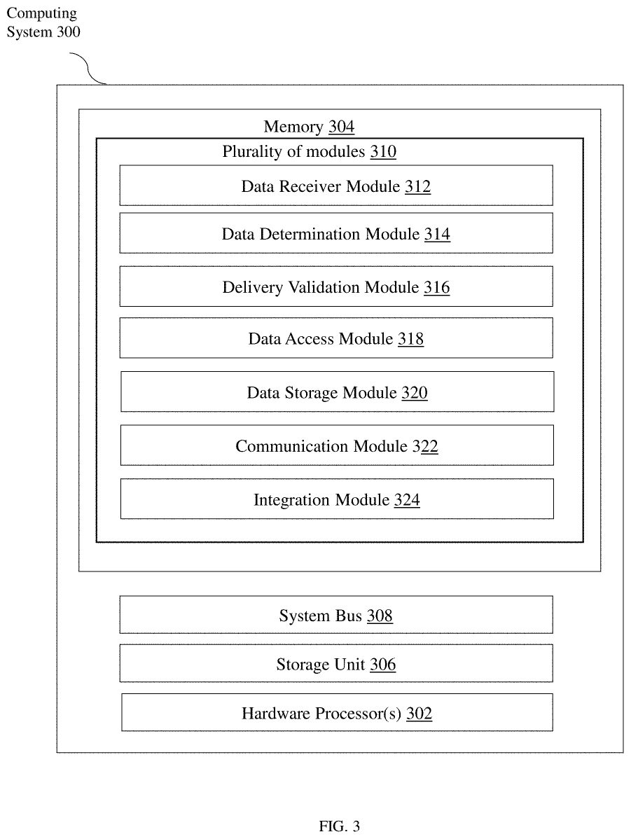

FIG. 3 is a block diagram illustrating an exemplary computing system 300 capable of facilitating multi-level security of data through blockchain network. In an embodiment of the present disclosure the computing system 300 may be each blockchain node. Alternatively, the computing system 300 may be a central server to which all the blockchain nodes are connected to. The computing system 300 comprises one or more hardware processors 302, a memory 304 and a storage unit 306. The one or more hardware processors 302, the memory 304 and the storage unit 306 are communicatively coupled through a system bus 308 or any similar mechanism. The memory 304 comprises a plurality of modules 310 in the form of programmable instructions executable by the one or more hardware processors 302. Further, the plurality of modules 310 includes a data receiver module 312, a data determination module 314, a data validation module 316, a data access module 318, a data storage module 320, a communication module 322, an integration module 324.

The one or more hardware processors 302, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 302 may also include embedded controllers, such as generic or programmable logic devices or arrays, application specific integrated circuits, single-chip computers, and the like.

The memory 304 may be non-transitory volatile memory and non-volatile memory. The memory 304 may be coupled for communication with the one or more hardware processors 302, such as being a computer-readable storage medium. The one or more hardware processors 302 may execute machine-readable instructions and/or source code stored in the memory 304. A variety of machine-readable instructions may be stored in and accessed from the memory 304. The memory 304 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 304 includes the plurality of modules 310 stored in the form of machine-readable instructions on any of the above-mentioned storage media and may be in communication with and executed by the one or more hardware processors 302.

In an embodiment of the present disclosure, each of the plurality of blockchain nodes includes the storage unit 306. The storage unit may store one or more user parameters, a prestored location of the blockchain node, a prestored hierarchical level of the blockchain node, a prestored sensitivity level of the specific resource and a prestored access level of the user. The storage unit 306 may also store hierarchically distributed resources.

The data receiver module 312 is configured to receive a request from a user for accessing a specific resource stored in a blockchain node of a blockchain network. The specific resource includes a set of transactions. In an embodiment of the present disclosure, the blockchain network includes a plurality of blockchain nodes. The blockchain nodes are arranged from highest level of the blockchain network to lowest level of the blockchain network. Further, the plurality of blockchain nodes in the blockchain network includes hierarchically distributed resources. In an embodiment of the present disclosure, the hierarchically distributed resources include a highest sensitivity level of the resources up till a lowest sensitivity level of the resources. The highest sensitivity level of the resources are stored at the highest level of the blockchain network and the lowest sensitivity level of the resources are stored at the lowest level of the blockchain network. Each of the blockchain nodes including highest sensitivity level of the resources includes all data set related to the resources. Furthermore, each of the blockchain nodes including lowest sensitivity level of the resources includes a part of the data set related to the resources. In an embodiment of the present disclosure, each of the blockchain nodes includes dataset related to the resources of blockchain nodes on its level or lower levels. When a particular level of the blockchain network is configured to have a consensus mode and there are multiple blockchain nodes on the particular level, blockchain consensus may be used. In an embodiment of the present disclosure, the blockchain network is an ordered blockchain network at the highest level. While transmitting data from the highest level to the lowest level of the blockchain network, unauthorized transactions are not transmitted from the highest level to the lowest level of the blockchain network. However, lower levels of the blockchain network may order transactions based on an order attribute on transactions the lower levels have access to. Thus, the lower levels are aware of missing transactions and number of the missing transactions. However, the lower levels may not have access to data associated with the missing transactions. In an embodiment of the present disclosure, each of the blockchain nodes is identical with each other in terms of API. However, the datasets stored in each of the blockchain nodes and configuration of each of the blockchain nodes may be different.

In an embodiment of the present disclosure, the received request includes the set of transactions. In an exemplary embodiment of the present disclosure, the set of transactions include origination server, origination user, resource requested, namespace and one or more actions associated with one or more privileges. The namespace includes a set of actions grouped for a certain permission level. In an embodiment of the present disclosure, the one or more privileges are permission levels, such as read only, write only and the like. In an embodiment of the present disclosure, the one or more actions are performed by the user based on the one or more privileges.

The data determination module 314 determines hierarchical level of the blockchain node within the blockchain network based on location of the blockchain node including the specific resource and the received request. In an exemplary embodiment of the present disclosure, the hierarchical level may be unclassified level 202, confidential level 204, secret level 206 or top-secret level 208. The data determination module 314 also determines sensitivity level of the specific resource within the blockchain node based on the location of the blockchain node. In an embodiment of the present disclosure, the sensitivity level of the specific resource may range from highest sensitivity level to the lowest sensitivity level. In an embodiment of the present disclosure, resources with highest sensitivity level may be stored at the top-secret level 208 and resources with lowest sensitivity level may be stored at the unclassified level 202. Furthermore, the data determination module 314 determines access level of the user requesting access of the specific resource based on one or more user parameters. In an exemplary embodiment of the present disclosure, the one or more user parameters include name, address, ID number and designation of the user. In determining the access level of the user requesting access of the specific resource based on the one or more user parameters, the data determination module 314 identifies the one or more user parameters of the user requesting access of the specific resource. Further, the data determination module 314 identifies one or more privileges associated with the user based on the identified one or more user parameters of the user. The data determination module 314 determines access level of the user based on the identified one or more privileges associated with the user. In an exemplary embodiment of the present disclosure, the access level of the user includes admin user, restricted user, guest user and the like.

The data validation module 316 is configured to validate the received request based on the location of the blockchain node, the determined hierarchical level of the blockchain node, the determined sensitivity level of the specific resource and the determined access level of the user. In validating the received request based on the location of the blockchain node, the determined hierarchical level of the blockchain node, the determined sensitivity level of the specific resource and the determined access level of the user, the data validation module 316 compares the location of the blockchain node, the determined hierarchical level of the blockchain node, the determined sensitivity level of the specific resource and the determined access level of the user with a corresponding prestored location of the blockchain node, a prestored hierarchical level of the blockchain node, a prestored sensitivity level of the specific resource and a prestored access level of the user. Further, the data validation module 316 validates the received request based on the result of comparison.

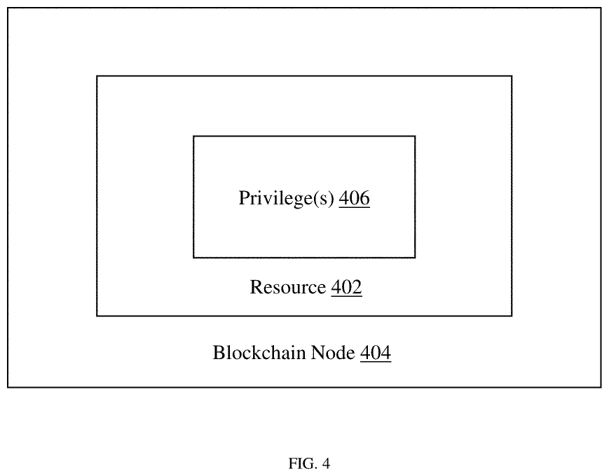

The data access module 318 is configured to provide access of the requested specific resource to the user upon successful validation of the received request. In an embodiment of the present disclosure, the specific resource is in encrypted form. The access of the requested specific resource within the blockchain node is provided to the user with one or more internal restrictions for additional security. In an embodiment of the present disclosure, the user may only connect with a single blockchain node at a time for accessing the requested specific resource. The one or more internal restrictions corresponds to user access controls. Since, the requested specific resource within the blockchain node is provided to the user with the one or more internal restrictions, the user is not allowed to access all data within the blockchain node. Details on the one or more internal restrictions have been elaborated in subsequent paragraphs of the present description with reference to FIG. 4. Further, the data access module 318 rejects the received request upon unsuccessful validation of the received request. In an embodiment of the present disclosure, when the user requests to access the specific resource stored in the blockchain node, the user is first required to access the blockchain node. Further, the user is required to access the resource stored in the blockchain node. Furthermore, the user is required to perform the one or more actions based on the one or more privileges on the node. For example, a weather satellite collects weather observations and publishes data associated with the weather observations to the unclassified level 202. User A requires to read the data while User B requires to command a new weather observation. Both User A and User B have access to the unclassified level 202 and the resource i.e., weather satellite. However, only User B is given command privileges while User A is given read access only. Thus, the user B may be provided with command privileges and the user A may be provided with read access only.

The data storage module 320 is configured to identify the resource to be stored in the blockchain network. Further, the data storage module 320 assigns a sensitivity level to the resource. The data storage module 320 stores the resource across a set of blockchain nodes of the blockchain network based on the assigned sensitivity level and hierarchical level of the set of blockchain nodes. In an embodiment of the present disclosure, the data storage module 320 determines whether the assigned sensitivity level of the resource is lowest sensitivity level. Furthermore, the data storage module 320 stores the resource across a set of blockchain nodes associated with lower hierarchal level in the blockchain network upon determining that the assigned sensitivity level of the resource is lowest sensitivity level. The data storage module 320 also publishes the resource to a set of blockchain nodes associated with higher hierarchal level in the blockchain network upon storing the resource across the set of blockchain nodes associated with the lower hierarchal level. Thus, the blockchain nodes including lowest sensitivity level of the resources includes a part of the data set related to the resources and the blockchain nodes including highest sensitivity level of the resources includes all data set related to the resources. In an embodiment of the present disclosure, the resource may be stored immutably.

The communication module 322 is configured to establish one or more communication channels between the plurality of blockchain nodes to facilitate communication between the plurality of blockchain nodes. In an embodiment of the present disclosure, two blockchain nodes may communicate with each other if a communication channel is established between the two blockchain nodes. The blockchain nodes may transmit the resource including the set of transactions to the blockchain nodes with higher hierarchical level. The plurality of blockchain nodes may validate the set of transactions, accept the resources, reject the resources and the like. In an embodiment of the present disclosure, the set of blockchain nodes associated with higher hierarchical level may have highest authority to validate the set of transactions, accept the resources, reject the resources and the like, such as a veto power. As used herein, the term ‘veto power’ refers to the power to unilaterally stop a privilege. In an embodiment of the present disclosure, when the privilege occurs at the highest hierarchical level, the data set associated with the resource may be released from the highest hierarchical level to the lower hierarchal level in the blockchain network.

In an embodiment of the present disclosure, plurality of cryptographic keys may be assigned to the plurality of blockchain nodes, such that the plurality of blockchain nodes may encrypt and decrypt their respective resources. Thus, if the resources are transmitted from the set of blockchain nodes associated with higher hierarchal level to the set of blockchain nodes associated with lower hierarchal level or if the resources are disclosed to unauthorized parties, the resources may still be secured due to encryption. In an embodiment of the present disclosure, each of the resources is cryptographically signed for particular blockchain nodes, such that the blockchain nodes with appropriate cryptographic keys may decrypt and verify the resources. The set of blockchain nodes associated with lower hierarchal level may transmit their cryptographic keys to the set of blockchain nodes associated with higher hierarchal level. In an embodiment of the present disclosure, the set of blockchain nodes associated with higher hierarchal level may access the resources stored in the set of blockchain nodes associated with lower hierarchal level, such that the set of blockchain nodes associated with higher hierarchal level may transmit the set of transactions to the blockchain nodes associated with lower hierarchal level via the one or more communication channels. In another embodiment of the present disclosure, the set of blockchain nodes associated with lower hierarchal level may only communicate to the set of blockchain nodes associated with higher hierarchal level via the one or more communication levels. In yet another embodiment of the present disclosure, the resources stored in the set of blockchain nodes associated with higher hierarchal level may not be accessed by the set of blockchain nodes associated with lower hierarchal level.

In an embodiment of the present disclosure, the cross-linking mechanism 210 may be set up between the two blockchain nodes. When a resource is stored in one blockchain node, the resource may be processed and published to a next blockchain node with same privilege via the cross-linking mechanism 210. Thus, the resources automatically flow through the blockchain network. For example, the satellite commands may be done at the secret level 206. Further, the user B has the secret level 206 access and the user A has read data access. When the user A desires to request a new experiment, the user A may be provided with a request privilege as the user A is not having the command access. The request privilege is transmitted to the higher hierarchical level to get it approved or rejected by the user B. Furthermore, response of the user B is transmitted down to the lower hierarchical level.

The integration module 324 is configured to integrate with one or more third parties by using one or more external endpoints. In an exemplary embodiment of the present disclosure, the one or more external endpoints include a publish Application Programming Interface (API), a subscription API, an actions API and the like. In an embodiment of the present disclosure, the publish API may provide access to one or more external applications for publishing the set of transactions into the blockchain network. The set of transactions may be denoted with the namespace and the privilege. For example, a transaction may be {resource: “weather-sat-1”, action: “file.read”, kwargs: {name: “weather-data-2020-04.json”}}. The subscription API may enable the one or more third parties with the access to listen to the set of transactions. In an embodiment of the present disclosure, when a transaction occurs, the blockchain node may immediately push the results to the one or more third parties having the access. The actions API may allow the one or more external parties to upload custom privileges onto the blockchain network. In an embodiment of the present disclosure, the actions API may be stored on each of the blockchain nodes. The custom privileges correspond to the smart contract. In an embodiment of the present disclosure, the smart contracts may be executed upon occurrence of one or more predefined conditions. The custom privileges may also kick off other events or notifications.

In operation, the computing system 300 receives a request from the user for accessing the specific resource stored in the blockchain node of the blockchain network. Further, the computing system 300 determines the hierarchical level of the blockchain node within the blockchain network based on the location of the blockchain node including the specific resource and the received request. Furthermore, the computing system 300 determines the sensitivity level of the specific resource within the blockchain node based on the location of the blockchain node. The computing system 300 determines the access level of the user requesting access of the specific resource based on one or more user parameters. Further, the computing system 300 validates the received request based on the location of the blockchain node, the determined hierarchical level of the blockchain node, the determined sensitivity level of the specific resource and the determined access level of the user. The computing system 300 provides access of the requested specific resource to the user upon successful validation of the received request.

FIG. 4 is a schematic representation of a blockchain node for facilitating multi-level security of data through blockchain network, in accordance with an embodiment of the present disclosure. In an embodiment of the present disclosure, when the user desires to access a resource 402 on a blockchain node 404, the user is first required to access the blockchain node 404. Further, the user is required to access the resource 402 upon accessing the blockchain node 404. Furthermore, the user is required to perform the one or more actions based on the one or more privileges 406 on the blockchain node 404 upon accessing the resource 402. In an embodiment of the present disclosure, the one or more internal restrictions may be placed within the blockchain node 404 for additional security. Further, the resource 402 may be internally restricted on the blockchain node 404, the resource 402 and the one or more privileges 406 level.

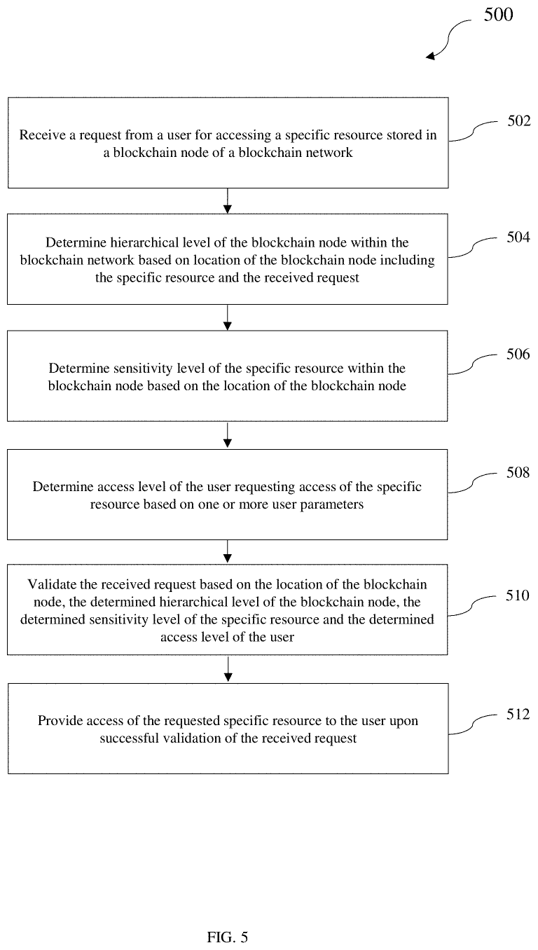

FIG. 5 is a process flow diagram illustrating an exemplary method for facilitating multi-level security of data through a blockchain network, in accordance with an embodiment of the present disclosure. At step 502, a request is received from a user for accessing a specific resource stored in a blockchain node of a blockchain network. The specific resource includes a set of transactions. In an embodiment of the present disclosure, the blockchain network includes a plurality of blockchain nodes. The blockchain nodes are arranged from highest level of the blockchain network to lowest level of the blockchain network. Further, the plurality of blockchain nodes in the blockchain network includes hierarchically distributed resources. In an embodiment of the present disclosure, the hierarchically distributed resources include a highest sensitivity level of the resources up till a lowest sensitivity level of the resources. The highest sensitivity level of the resources are stored at the highest level of the blockchain network and the lowest sensitivity level of the resources are stored at the lowest level of the blockchain network. Each of the blockchain nodes including highest sensitivity level of the resources includes all data set related to the resources. Furthermore, each of the blockchain nodes including lowest sensitivity level of the resources includes a part of the data set related to the resources. In an embodiment of the present disclosure, each of the blockchain nodes includes dataset related to the resources of blockchain nodes on its level or lower levels. When a particular level of the blockchain network is configured to have a consensus mode and there are multiple blockchain nodes on the particular level, blockchain consensus may be used. In an embodiment of the present disclosure, the blockchain network is an ordered blockchain network at the highest level. While transmitting data from the highest level to the lowest level of the blockchain network, unauthorized transactions are not transmitted from the highest level to the lowest level of the blockchain network. However, lower levels of the blockchain network may order transactions based on an order attribute on transactions the lower levels have access to. Thus, the lower levels are aware of missing transactions and number of the missing transactions. However, the lower levels may not have access to data associated with the missing transactions. In an embodiment of the present disclosure, each of the blockchain nodes is identical with each other in terms of API. However, the datasets stored in each of the blockchain nodes and configuration of each of the blockchain nodes may be different.

In an embodiment of the present disclosure, the received request includes the set of transactions. In an exemplary embodiment of the present disclosure, the set of transactions include origination server, origination user, resource requested, namespace and one or more actions associated with one or more privileges. The namespace includes a set of actions grouped for a certain permission level. In an embodiment of the present disclosure, the one or more privileges are permission levels, such as read only, write only and the like. In an embodiment of the present disclosure, the one or more actions are performed by the user based on the one or more privileges.

At step 504, hierarchical level of the blockchain node within the blockchain network is determined based on location of the blockchain node including the specific resource and the received request. In an exemplary embodiment of the present disclosure, the hierarchical level may be unclassified level 202, confidential level 204, secret level 206 or top-secret level 208.

At step 506, sensitivity level of the specific resource within the blockchain node is determined based on the location of the blockchain node. In an embodiment of the present disclosure, the sensitivity level of the specific resource may range from highest sensitivity level to the lowest sensitivity level. In an embodiment of the present disclosure, resources with highest sensitivity level may be stored at the top-secret level 208 and resources with lowest sensitivity level may be stored at the unclassified level 202.

At step 508, access level of the user requesting access of the specific resource is determined based on one or more user parameters. In an exemplary embodiment of the present disclosure, the one or more user parameters include name, address, ID number and designation of the user. In determining the access level of the user requesting access of the specific resource based on the one or more user parameters, the method 500 includes identifying the one or more user parameters of the user requesting access of the specific resource. Further, the method 500 includes identifying one or more privileges associated with the user based on the identified one or more user parameters of the user. The method 500 includes determining access level of the user based on the identified one or more privileges associated with the user. In an exemplary embodiment of the present disclosure, the access level of the user includes admin user, restricted user, guest user and the like.

At step 510, the received request is validated based on the location of the blockchain node, the determined hierarchical level of the blockchain node, the determined sensitivity level of the specific resource and the determined access level of the user. In validating the received request based on the location of the blockchain node, the determined hierarchical level of the blockchain node, the determined sensitivity level of the specific resource and the determined access level of the user, the method 500 includes comparing the location of the blockchain node, the determined hierarchical level of the blockchain node, the determined sensitivity level of the specific resource and the determined access level of the user with a corresponding prestored location of the blockchain node, a prestored hierarchical level of the blockchain node, a prestored sensitivity level of the specific resource and a prestored access level of the user. Further, the method 500 includes validating the received request based on the result of comparison.

At step 512, access of the requested specific resource is provided to the user upon successful validation of the received request. In an embodiment of the present disclosure, the specific resource is in encrypted form. The access of the requested specific resource within the blockchain node is provided to the user with one or more internal restrictions for additional security. In an embodiment of the present disclosure, the user may only connect with a single blockchain node at a time for accessing the requested specific resource. The one or more internal restrictions corresponds to user access controls. Since, the requested specific resource within the blockchain node is provided to the user with the one or more internal restrictions the user is not allowed to access all data within the blockchain node. Further, the received request is rejected upon unsuccessful validation of the received request. In an embodiment of the present disclosure, when the user requests to access the specific resource stored in the blockchain node, the user is first required to access the blockchain node. Further, the user is required to access the resource stored in the blockchain node. Furthermore, the user is required to perform the one or more actions based on the one or more privileges on the node. For example, a weather satellite collects weather observations and publishes data associated with the weather observations to the unclassified level 202. User A requires to read the data while User B requires to command a new weather observation. Both User A and User B have access to the unclassified level 202 and the resource i.e., weather satellite. However, only User B is given command privileges while User A is given read access only. Thus, the user B may be provided with command privileges and the user A may be provided with read access only.

The method 500 includes identifying the resource to be stored in the blockchain network. Further, the method 500 includes assigning a sensitivity level to the resource. The method 500 includes storing the resource across a set of blockchain nodes of the blockchain network based on the assigned sensitivity level and hierarchical level of the set of blockchain nodes. In an embodiment of the present disclosure, the method 500 includes determining whether the assigned sensitivity level of the resource is lowest sensitivity level. Furthermore, the method 500 includes storing the resource across a set of blockchain nodes associated with lower hierarchal level in the blockchain network upon determining that the assigned sensitivity level of the resource is lowest sensitivity level. The method 500 also includes publishing the resource to a set of blockchain nodes associated with higher hierarchal level in the blockchain network upon storing the resource across the set of blockchain nodes associated with the lower hierarchal level. Thus, the blockchain nodes including lowest sensitivity level of the resources includes a part of the data set related to the resources and the blockchain nodes including highest sensitivity level of the resources includes all data set related to the resources. In an embodiment of the present disclosure, the resource may be stored immutably.

The method 500 includes establishing one or more communication channels between the plurality of blockchain nodes to facilitate communication between the plurality of blockchain nodes. In an embodiment of the present disclosure, two blockchain nodes may communicate with each other if a communication channel is established between the two blockchain nodes. The blockchain nodes may transmit the resource including the set of transactions to the blockchain nodes with higher hierarchical level. The plurality of blockchain nodes may validate the set of transactions, accept the resources, reject the resources and the like. In an embodiment of the present disclosure, the set of blockchain nodes associated with higher hierarchical level may have highest authority to validate the set of transactions, accept the resources, reject the resources and the like, such as a veto power. As used herein, the term ‘veto power’ refers to the power to unilaterally stop a privilege. In an embodiment of the present disclosure, when the privilege occurs at the highest hierarchical level, the data set associated with the resource may be released from the highest hierarchical level to the lower hierarchal level in the blockchain network.

In an embodiment of the present disclosure, plurality of cryptographic keys may be assigned to the plurality of blockchain nodes, such that the plurality of blockchain nodes may encrypt and decrypt their respective resources. Thus, if the resources are transmitted from the set of blockchain nodes associated with higher hierarchal level to the set of blockchain nodes associated with lower hierarchal level or if the resources are disclosed to unauthorized parties, the resources may still be secured due to encryption. In an embodiment of the present disclosure, each of the resources is cryptographically signed for particular blockchain nodes, such that the blockchain nodes with appropriate cryptographic keys may decrypt and verify the resources. The set of blockchain nodes associated with lower hierarchal level may transmit their cryptographic keys to the set of blockchain nodes associated with higher hierarchal level. In an embodiment of the present disclosure, the set of blockchain nodes associated with higher hierarchal level may access the resources stored in the set of blockchain nodes associated with lower hierarchal level, such that the set of blockchain nodes associated with higher hierarchal level may transmit the set of transactions to the blockchain nodes associated with lower hierarchal level via the one or more communication channels. In another embodiment of the present disclosure, the set of blockchain nodes associated with lower hierarchal level may only communicate to the set of blockchain nodes associated with higher hierarchal level via the one or more communication levels. In yet another embodiment of the present disclosure, the resources stored in the set of blockchain nodes associated with higher hierarchal level may not be accessed by the set of blockchain nodes associated with lower hierarchal level.

In an embodiment of the present disclosure, a cross-linking mechanism 210 may be set up between the two blockchain nodes. When a resource is stored in one blockchain node, the resource may be processed and published to a next blockchain node with same privilege. Thus, the resources automatically flow through the blockchain network. For example, the satellite commands may be done at the secret level 206. Further, the user B has the secret level 206 access and the user A has read data access. When the user A desires to request a new experiment, the user A may be provided with a request privilege as the user A is not having the command access. The request privilege is transmitted to the higher hierarchical level to get it approved or rejected by the user B. Furthermore, response of the user B is transmitted down to the lower hierarchical level.

The method 500 includes integrating with one or more third parties by using one or more external endpoints. In an exemplary embodiment of the present disclosure, the one or more external endpoints include a publish Application Programming Interface (API), a subscription API, an actions API and the like. In an embodiment of the present disclosure, the publish API may provide access to one or more external applications for publishing the set of transactions into the blockchain network. The set of transactions may be denoted with the namespace and the privilege. For example, a transaction may be {resource: “weather-sat-1”, action: “file.read”, kwargs: {name: “weather-data-2020-04.json”}}. The subscription API may enable the one or more third parties with the access to listen to the set of transactions. In an embodiment of the present disclosure, when a transaction occurs, the blockchain node may immediately push the results to the one or more third parties having the access. The actions API may allow the one or more external parties to upload custom privileges onto the blockchain network. In an embodiment of the present disclosure, the actions API may be stored on each of the blockchain nodes. The custom privileges correspond to the smart contract. In an embodiment of the present disclosure, the smart contracts may be executed upon occurrence of one or more predefined conditions. The custom privileges may also kick off other events or notifications.

The method 500 may be implemented in any suitable hardware, software, firmware, or combination thereof.

Thus, various embodiments of the present computing system 300 provide a solution to facilitate multi-level security of data through the blockchain network. Since, the computing system 300 stores the resources at multiple levels with highest sensitive resource stored at the highest level, the highest sensitive resource is inaccessible to the lower levels. Thus, the computing system 300 helps in preventing the resources from untrusted third-party access. Further, the computing system 300 provides the access of the requested specific resource within the blockchain node with the one or more internal restrictions, which helps in increasing the security of the resources. Also, the resources are only available for the users who are authorized to access them.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 308 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A computing system for facilitating multi-level security of data through blockchain network, the computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
a data receiver module configured to receive a request from a user for accessing a specific resource stored in a blockchain node of a blockchain network;
a data determination module configured to:
determine hierarchical level of the blockchain node within the blockchain network based on location of the blockchain node comprising the specific resource and the received request;
determine sensitivity level of the specific resource within the blockchain node based on the location of the blockchain node; and
determine access level of the user requesting access of the specific resource based on one or more user parameters, wherein the one or more user parameters comprise: name, address, ID number and designation of the user;
a data validation module configured to validate the received request based on the location of the blockchain node, the determined hierarchical level of the blockchain node, the determined sensitivity level of the specific resource and the determined access level of the user; and
a data access module configured to provide access of the requested specific resource to the user upon successful validation of the received request.

2. The computing system of claim 1, wherein the data access module is configured to reject the received request upon unsuccessful validation of the received request.

3. The computing system of claim 1, wherein in validating the received request based on the location of the blockchain node, the determined hierarchical level of the blockchain node, the determined sensitivity level of the specific resource and the determined access level of the user, the data validation module is configured to:
compare the location of the blockchain node, the determined hierarchical level of the blockchain node, the determined sensitivity level of the specific resource and the determined access level of the user with a corresponding prestored location of the blockchain node, a prestored hierarchical level of the blockchain node, a prestored sensitivity level of the specific resource and a prestored access level of the user; and
validate the received request based on the result of comparison.

4. The computing system of claim 1, wherein the blockchain network comprises a plurality of blockchain nodes, wherein the plurality of blockchain nodes in the blockchain network comprises hierarchically distributed resources, wherein the hierarchically distributed resources comprise a highest sensitivity level of the resources up till a lowest sensitivity level of the resources, wherein each of the blockchain nodes comprising highest sensitivity level of the resources comprises all data set related to the resources and wherein each of the blockchain nodes comprising lowest sensitivity level of the resources comprises a part of the data set related to the resources.

5. The computing system of claim 1, further comprises a data storage module configured to:
identify the resource to be stored in the blockchain network;
assign a sensitivity level to the resource; and
store the resource across a set of blockchain nodes of the blockchain network based on the assigned sensitivity level and hierarchical level of the set of blockchain nodes.

6. The computing system of claim 1, wherein in determining the access level of the user requesting access of the specific resource based on the one or more user parameters, the data determination module is configured to:
identify the one or more user parameters of the user requesting access of the specific resource;
identify one or more privileges associated with the user based on the identified one or more user parameters of the user; and
determine access level of the user based on the identified one or more privileges associated with the user, wherein the access level of the user comprises: admin user, restricted user and guest user.

7. The computing system of claim 1, wherein the received request comprises a set of transactions, wherein the set of transactions comprise: origination server, origination user, resource requested, namespace and one or more actions associated with one or more privileges, wherein the namespace comprises: a set of actions grouped for a certain permission level and wherein the one or more privileges comprises: read only and write only.

8. The computing system of claim 5, wherein the data storage module is configured to:
determine whether the assigned sensitivity level of the resource is lowest sensitivity level;
store the resource across a set of blockchain nodes associated with lower hierarchal level in the blockchain network upon determining that the assigned sensitivity level of the resource is lowest sensitivity level; and
publish the resource to a set of blockchain nodes associated with higher hierarchal level in the blockchain network upon storing the resource across the set of blockchain nodes associated with the lower hierarchal level.

9. The computing system of claim 4, further comprises a communication module configured to establish one or more communication channels between the plurality of nodes to facilitate communication between the plurality of nodes.

10. The computing system of claim 1, further comprises an integration module configured to integrate with one or more third parties by using one or more external endpoints, wherein the one or more external endpoints comprise: a publish Application Programming Interface (API), a subscription API and an actions API.

11. The computing system of claim 1, wherein the access of the requested specific resource within the blockchain node is provided to the user with one or more internal restrictions.

12. A method for facilitating multi-level security of data through blockchain network, the method comprising:
receiving, by one or more hardware processors, a request from a user for accessing a specific resource stored in a blockchain node of a blockchain network;
determining, by the one or more hardware processors, hierarchical level of the blockchain node within the blockchain network based on location of the blockchain node comprising the specific resource and the received request;
determining, by the one or more hardware processors, sensitivity level of the specific resource within the blockchain node based on the location of the blockchain node;
determining, by the one or more hardware processors, access level of the user requesting access of the specific resource based on one or more user parameters, wherein the one or more user parameters comprise: name, address, ID number and designation of the user;
validating, by the one or more hardware processors, the received request based on the location of the blockchain node, the determined hierarchical level of the blockchain node, the determined sensitivity level of the specific resource and the determined access level of the user; and
providing, by the one or more hardware processors, access of the requested specific resource to the user upon successful validation of the received request.

13. The method of claim 12, further comprises rejecting the received request upon unsuccessful validation of the received request.

14. The method of claim 12, wherein validating the received request based on the location of the blockchain node, the determined hierarchical level of the blockchain node, the determined sensitivity level of the specific resource and the determined access level of the user comprises:
comparing the location of the blockchain node, the determined hierarchical level of the blockchain node, the determined sensitivity level of the specific resource and the determined access level of the user with a corresponding prestored location of the blockchain node, a prestored hierarchical level of the blockchain node, a prestored sensitivity level of the specific resource and a prestored access level of the user; and
validating the received request based on the result of comparison.

15. The method of claim 12, wherein the blockchain network comprises a plurality of blockchain nodes, wherein the plurality of blockchain nodes in the blockchain network comprises hierarchically distributed resources, wherein the hierarchically distributed resources comprise a highest sensitivity level of the resources up till a lowest sensitivity level of the resources, wherein each of the blockchain nodes comprising highest sensitivity level of the resources comprises all data set related to the resources and wherein each of the blockchain nodes comprising lowest sensitivity level of the resources comprises a part of the data set related to the resources.

16. The method of claim 12, further comprises:
identifying the resource to be stored in the blockchain network;
assigning a sensitivity level to the resource; and
storing the resource across a set of blockchain nodes of the blockchain network based on the assigned sensitivity level and hierarchical level of the set of blockchain nodes.

17. The method of claim 12, wherein determining the access level of the user requesting access of the specific resource based on the one or more user parameters comprises:
identifying the one or more user parameters of the user requesting access of the specific resource;
identifying one or more privileges associated with the user based on the identified one or more user parameters of the user; and
determining access level of the user based on the identified one or more privileges associated with the user, wherein the access level of the user comprises: admin user, restricted user and guest user.

18. The method of claim 12, wherein the received request comprises a set of transactions, wherein the set of transactions comprise: origination server, origination user, resource requested, namespace and one or more actions associated with one or more privileges, wherein the namespace comprises: a set of actions grouped for a certain permission level and wherein the one or more privileges comprises: read only an write only.

19. The method of claim 16, further comprises:
determining whether the assigned sensitivity level of the resource is lowest sensitivity level;
storing the resource across a set of blockchain nodes associated with lower hierarchal level in the blockchain network upon determining that the assigned sensitivity level of the resource is lowest sensitivity level; and
publishing the resource to a set of blockchain nodes associated with higher hierarchal level in the blockchain network upon storing the resource across the set of blockchain nodes associated with the lower hierarchal level.

20. The method of claim 15, further comprises establishing one or more communication channels between the plurality of nodes to facilitate communication between the plurality of nodes.

21. The method of claim 12, further comprises integrating with one or more third parties by using one or more external endpoints, wherein the one or more external endpoints comprise: a publish Application Programming Interface (API), a subscription API and an actions API.

22. The method of claim 12, wherein the access of the requested specific resource within the blockchain node is provided to the user with one or more internal restrictions.
